(19) United States
(12) Patent Application Publication
(10) Pub. No.: US 2024/0027818 A1
(43) Pub. Date: Jan. 25, 2024

(54) IR STABLE AND UV STABLE SWITCHABLE PANEL AND METHODS FOR MAKING AND USING

(71) Applicant: Jiansheng Wang, The Colony, TX (US)

(72) Inventor: Jiansheng Wang, The Colony, TX (US)

(21) Appl. No.: 17/778,105

(22) PCT Filed: Aug. 20, 2021
(86) PCT No.: PCT/US2021/046893

§ 371 Date: May 19, 2022

Related U.S. Application Data
(60) Provisional application No. 63/103,801, filed on Aug. 24, 2020.

(51) Int. Cl. G02F 1/1335; G02F 1/1334

(52) U.S. Cl. CPC G02F 1/133509; G02F 1/1334

(57) ABSTRACT

A Liquid Crystal Micro-Droplet (LCMD) apparatus that is protected from IR and UV radiations, includes: a transparent layer, a transparent conductive layer, a liquid crystal-polymer matrix layer that comprises a solid polymer and a plurality of liquid crystal droplets dispersed within the solid polymer, and an infrared filtration layer wherein the infrared filtration layer stabilizes the apparatus from IR radiation and UV radiation.

### CROSS-REFERENCE TO RELATED APPLICATION

This application is a U.S. National Phase application under 35 U.S.C. § 371 of International Patent Application No. PCT/US2021/046893, filed on Aug. 20, 2021, which claims priority to U. S. Provisional Patent Application No. 63/103,801, filed on Aug. 24, 2020. The entire contents of the parent applications are hereby incorporated by reference.

### FIELD OF INVENTION

This specification generally relates to switchable panels and methods for making and using the same. In particular, this specification is directed to liquid crystal microdroplet (LCMD) devices, suspended particle devices (SPDs), or electrochromic or thermochromic materials that are stable under IR (IR) and UV (UV) exposures.

### BACKGROUND

Continued advancements in the field of optoelectronics have led to the development of liquid crystal microdroplet (LCMD) devices. In this type of display, a liquid crystal (LC) material is contained in microdroplets that are embedded in a solid polymer matrix. The LCMD displays have several advantageous properties, for example, an LCMD display can be made in a form of a film in a large size or in a curved shape, which can be easily customized and incorporated into a device.

In order to make LCMD film more durable, an LCMD film is often laminated between two layers of glass with interlayers or assembled into a multi-layer panel. Such a laminated glass panel is often called a smart glass or a switchable window.

There exists a need for devices that use improved LCMD technologies for outdoor applications and switchable window systems to provide improved stability in outdoor environments against all kinds of weather. Preferably, the improved switchable panels are not significantly affected by IR radiation and UV radiation from the sunlight.

### SUMMARY

This specification provides an improved Liquid Crystal Micro-Droplet (LCMD) apparatus that is protected from IR and UV radiations. This improved LCMD apparatus is termed as an anti-IR LCMD apparatus, and includes: a transparent layer, a transparent conductive layer, a LC-polymer matrix layer that comprises a solid polymer and a plurality of liquid crystal droplets dispersed within the solid polymer, and an infrared filtration layer wherein the infrared filtration layer stabilizes the apparatus from IR radiation and UV radiation. The anti-IR LCMD apparatus can be with or without including one or more UV absorbers.

In some implementations, the anti-UV LCMD apparatus includes a compound that stabilizes the apparatus from UV radiation and the compound is present in one or more of the plurality of liquid crystal droplets and the solid polymer and the transparent layer.

In some implementations of the anti-IR LCMD apparatus, the infrared filtration layer comprises a silver-coated layer covered with a dielectric layer.

In some implementations of the anti-IR LCMD apparatus, the infrared filtration layer comprises a layer of a dielectric material deposited with nanoparticles.

In some implementations of the anti-IR LCMD apparatus, the infrared filtration layer comprises nanoparticles of indium tin oxide (ITO).

In some implementations of the anti-IR LCMD apparatus, the infrared filtration layer is configured between the transparent layer and the transparent conductive layer, where a first surface of the infrared filtration layer is in contact with the transparent layer and a second surface of the infrared filtration layer is in contact with the transparent conductive layer.

In some implementations of the anti-IR LCMD apparatus, a first surface of the infrared filtration layer is configured in contact with the transparent layer and a second surface of the infrared filtration layer is in contact with an external environment of the anti-IR LCMD device.

In some implementations of the anti-IR LCMD apparatus, the infrared filtration layer is a first infrared filtration layer, and the anti-IR LCMD further comprises a second infrared filtration layer.

In some implementations of the anti-IR LCMD apparatus, the first infrared filtration layer and the second infrared filtration layer have same thickness.

In some implementations of the anti-IR LCMD apparatus, the first infrared filtration layer and the second infrared filtration layer have different thicknesses.

In some implementations of the anti-IR LCMD apparatus, the first infrared filtration layer and the second infrared filtration layer comprise same materials.

In some implementations of the anti-IR LCMD apparatus, the first infrared filtration layer and the second infrared filtration layer comprise different materials.

In some implementations, the anti-IR LCMD apparatus includes an infrared filtration layer and a compound that stabilizes the apparatus from UV radiation and the compound is present in one or more of the plurality of liquid crystal droplets and the solid polymer and the transparent layer.

Additional aspects, features, and advantages of the present specification will become apparent from the following detailed description.

### BRIEF DESCRIPTION OF THE DRAWINGS

The present specification is best understood from the following detailed description when read with accompanying figures. It is emphasized that, in accordance with the standard practice in the industry, various features are not drawn to scale and are used for illustration purposes only. In fact, the dimension of the various features may be arbitrarily increased or reduced for clarity of discussion.

FIG. 1A shows a cross-sectional view of an example of an anti-IR LCMD film according to certain embodiments of this specification.

FIG. 1B shows a cross-sectional view of another example of an anti-IR LCMD film according to certain embodiments of this specification.

FIG. 1C shows a cross-sectional view of another example of an anti-IR LCMD film according to certain embodiments of this specification

FIG. 2A shows a cross-sectional view of an example of a laminated anti-IR LCMD panel.

FIG. 2B shows a cross-sectional view of an example of an anti-IR LCMD switchable projection panel.

FIG. 3 shows a comparison of the transmittance spectra for several IR coatings.

FIG. 4 shows the optoelectronic properties for several anti-IR LCMD films with one or more UV absorbers.

Like reference numbers and designations in the various drawings indicate like elements.

### DETAILED DESCRIPTION

When a switchable device is used in an outdoor application, for example, as a switchable window, the device is exposed to the sunlight. The sunlight contains electromagnetic energy with wavelengths in the IR range, the visible range, and the UV range. Both the IR and UV light can damage a switchable device. For example, IR light can damage a switchable device by increasing the device temperature, promoting destructive reactions in the component materials that contain impurities, and causing a reduction in the device's lifetime. UV rays can damage a switchable device by directly breaking molecular bonds in organic component materials of the device.

Since LC-based devices offer high transparency in the clear mode compared to many other types of switchable devices, they are particularly vulnerable to IR and UV exposure from the sunlight. Therefore, although LCMD-based switchable devices have been introduced into the market for over three decades, applications are mostly limited to indoor conditions because of inadequate stability from the radiations in the sunlight. There is a need to increase the stability of switchable windows against IR rays and UV rays for various outdoor applications.

Further, for a switchable window, the IR light and UV light are not only damaging to the switchable device itself, but also undesirable in the indoor environment when passing through the switchable window. The IR light is a carrier of heat energy causing increased power consumption of indoor air-conditioning, while the UV light can directly damage any organic materials, such as fading furniture paint and aging plastic products.

Further, conventional LCMD-based switchable glass can be switched between a transparent state and an opaque state with a milk-while color. When used as a window, e.g., for an automotive or a building, the milk-white color of the opaque state of the glass may not be esthetically desirable according to user preferences.

Switchable devices can be categorized according to component structures of the device, including, for example, (1) a switchable film or panel, such as an LCMD film, (2) a laminated LC switchable glass, and (3) a switchable projection panel.

The LCMD film includes an LC-polymer matrix, which is an optically active layer that is responsible for the switching function. The LC-polymer matrix includes a plurality of liquid crystal microdroplets embedded in a solid polymer.

There are several types of LCMD films with different fabrication approaches.

In one example of the LCMD film, the device includes a nematic curvilinear aligned phase (NCAP) film, such as described in U.S. Pat. No. 4,435,047.

In another example of the LCMD film, the device includes a polymer dispersed liquid crystal (PDLC) film formed by phase separation in a homogenous polymer matrix, such as described in U.S. Pat. No. 4,688,900.

The solid polymer is a homogeneous polymer for NCAP films and PDLC films.

In another example of the LCMD film, the device includes a non-homogenous polymer dispersed liquid crystal display (NPD-LCD) formed using a non-homogenous light transmissive copolymer matrix with dispersed droplets of liquid crystal material, such as described in U.S. Pat. No. 5,270,843, which is incorporated by reference herein in its entirety for all purposes and teachings. The solid polymer is a non-homogeneous polymer in NPD-LCD films with gradually changed refractive indexes.

Other types of switchable devices, such as suspended particle device (SPD), electrochromic and thermochromic materials, essentially have the same layer structure but different optically active layers.

This specification provides LCMD films and panels that are IR and UV stable. That is, the device, and in particular, an optically active layer, is protected from IR and UV rays.

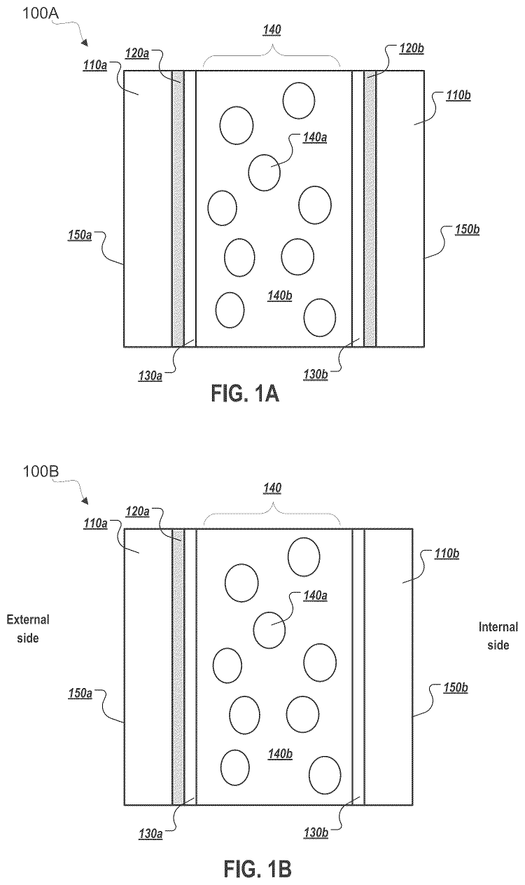

FIG. 1A shows a cross-sectional view of an example of an anti-IR LCMD film 100 according to certain embodiments of the present specification.

The anti-IR LCMD film 100 includes a layered structure including: a first transparent film 110a, a first IR coating 120a, a first transparent and conductive coating 130a, an LC-polymer matrix 140, a second transparent and conductive coating 130b, a second IR coating 120b, and a second transparent film 110b. Each of the film surfaces 150a and 150b can be an air-solid interface or an air-film interface.

The transparent films 110a and 110b can be made of any appropriate materials, such as a polyethylene terephthalate (PET) or a polycarbonate film. The transparent and conductive coating 130a and 130b can be an indium tin oxide (ITO) coating.

The LC-polymer matrix 140 includes a plurality of LC microdroplets 140a embedded in a solid polymer 140b. The LC microdroplets 140a can have a size range of 0.05 to 10 microns. There are several types of the LC-polymer matrix layer with different fabrication approaches.

One approach to disperse liquid crystal microdroplets in a polymer matrix is the method of encapsulating or emulsifying the LC material and suspending the liquid crystals in a film which is then polymerized. This approach is described, for example, in U.S. Pat. Nos. 4,435,047; 4,605,284; and 4,707,080. This process includes mixing positive liquid crystals and encapsulating material, in which the liquid crystals are insoluble, and permitting the formation of discrete capsules containing the liquid crystals. The emulsion is cast on a substrate, which is precoated with a transparent electrode, such as an indium tin oxide (ITO) coating, to form an encapsulated liquid crystal device.

The LC-polymer matrix can also be formed by phase separation of low-molecular-weight liquid crystals from a prepolymer or solution of monomers to form microdroplets of liquid crystals. This process, described in U.S. Pat. Nos. 4,685,771 and 4,688,900, includes dissolving positive liquid crystals in an uncured resin and then sandwiching the mixture between two substrates which are precoated with transparent electrodes. The resin is then cured so that microdroplets of liquid crystals are formed and uniformly dispersed in the cured resin to form a polymer dispersed liquid crystal (PDLC) device. When an AC voltage is applied between the two transparent electrodes, the positive liquid crystals in microdroplets are oriented and the display is transparent if the refractive index of the polymer matrix (nₚ) is made to equal the ordinary index of the liquid crystals (nₒ). The display scatters light in the absence of the electric field, because the directors (vector in the direction of the long axis of the molecules) of the liquid crystals are random and the refractive index of the polymer cannot match the index of the liquid crystals. Nematic liquid crystals having a positive dielectric anisotropy (Δε>0), large Δn, which may contain a dichroic dye mixture, can be used to form a transparent and an absorbing mode.

The LC-polymer matrix may also be formed by using a non-homogenous polymer dispersed liquid crystal display (NPD-LCD) technology or using a non-homogenous light transmissive copolymer matrix with dispersed droplets of liquid crystal material. This system and devices are described in U.S. Pat. No. 5,270,843. An NPD-LCD device may be configured in one of two modes. In a positive mode, an NPD-LCD device is switchable between an opaque state without an applied electrical voltage and a clear state with an applied electrical voltage. In the positive mode, positive liquid crystals having a positive dielectric anisotropy (Δε>0) and a large Δn, which may contain a dichroic dye mixture, can be used to form a transparent and an absorbing mode of positive NPD-LCD device. In a negative mode or reverse mode, an NPD-LCD device is switchable between a clear state without an applied electrical voltage and an opaque state with an applied electrical voltage. In the negative mode, negative liquid crystals having a negative dielectric anisotropy (Δε<0) and a large Δn, which may contain a dichroic dye mixture, can be used to form a transparent and an absorbing mode of negative NPD-LCD device. A reason of which the NPD-LCD device may have a negative mode is because the copolymer may change its surface tension or surface energy during the curing process. This feature resolves a conflict in formation of the LC droplets and a required relationship of surface tension between the solid polymer and liquid crystals. The Friedel-Creagh-Kmetz (FCK) rule in physical chemistry requires that dispersed LC droplets can only be formed with a polymer with a greater surface tension than the surface tension of the liquid crystals, but the negative mode of LCMD device requires that the final surface tension of the solid polymer must be smaller than the surface tension of liquid crystals in the droplets. The NPD-LCD technology may roughly form liquid droplets with fast reactive monomers having large surface tensions. After formation of the liquid droplets, slower reactive monomers having small surface tensions contained in the liquid droplets continue to carry on the polymerization and complete the formation of LC-polymer matrix with smaller surface tensions on inner surfaces of LC droplets.

In this specification, the terms “LCMD device”, “LCMD film”, or “LCMD display” refer to a device, a film, or a display, respectively, formed using various classes of polymer films, including above mentioned three generations of LCMD or the NCAP, PDLC and NPD-LCD films. The improved LCMD apparatus provided by this specification is protected from IR and UV radiations, and is termed as an “anti-IR LCMD” apparatus with or without containing one or more UV absorbers.

The IR coating 120a can be configured between the transparent film 110a and the conductive coating 130a. Similarly, the IR coating 120b can be configured between the transparent film 110b and the conductive coating 130b.

In this specification, the terms “IR coating”, “anti-IR coating”, and “IR filtration layer” are interchangeably used. The IR coatings 120a and 120b can be any suitable type of IR coating that filters or attenuates IR rays. The IR coatings can further filter or attenuate UV rays. The IR coatings 120a and 120b provide protection for the LC-polymer matrix layer 140 which is the most vulnerable component of an LCMD device to IR and UV exposure.

The IR coatings 120a and 120b can have the same thickness or a different thickness according to the applications.

In some implementations, the IR coatings are associated with a specific set of optical property parameters in the visible light range, and thus provide a specific color to the anti-IR LCMD film 100. Therefore, the color of the anti-IR LCMD film 100 can be chosen according to the application and user preference by choosing IR coatings with the appropriate optical property. By choosing a different IR coating, the colors of the anti-IR film 100 can be different. This feature is useful in many fields including automobile glass and architecture glass.

Further, the IR coatings can be made using one or more weather-stable materials, e.g., an inorganic material that remains stable in various weather conditions. Thus, the IR coatings as a new component in an LCMD device can provide improvement in the weather stability of the device as a whole.

Many materials can be used as IR coatings for various applications. There are several methods to add the anti-IR coating to the conductive film (e.g., an ITO film).

In some implementations, the silver metal can be used as the IR coatings for a window application. For example, the IR coating can be a silver-coated layer covered with a dielectric layer, such as a ceramic layer. By manipulating the layer thickness, composition of layer materials and the number of layers, the IR coating layer or coating stack can be used to control the visual and thermal properties of anti-IR LCMD film. These modifications may drastically reduce heat and light passing through and increase the stability of anti-IR LCMD devices.

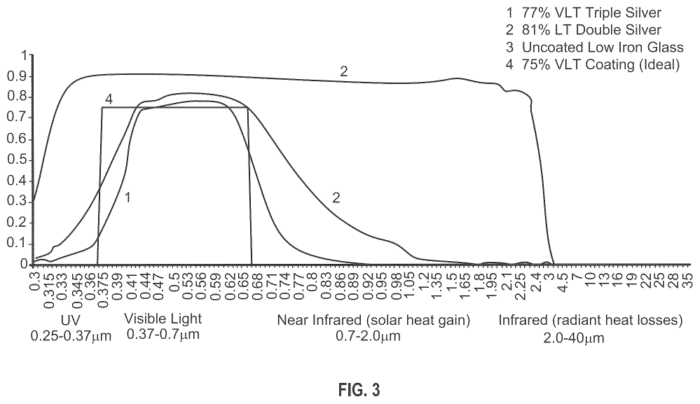

FIG. 3 shows the measured light transmittance spectra of different silver IR coatings (on a low iron glass substrate with 6 mm thickness). An uncoated low iron glass substrate provides a 91% visual light transmission (VLT), as shown in spectrum #3. A double silver coating provides an 81% VLT, as shown in spectrum #2. A triple silver low-e coating provides an 77% VLT, as shown in spectrum #1 (77%). The spectrum #4 illustrates an ideal coating with 75% VLT with complete blocking of the UV and IR wavelength ranges.

As shown in the measured spectra of FIG. 3, different thicknesses and the number of coating layers have different efficiency in light filtration and provide different colors. These layers may be collectively termed as the IR coating layer regardless of the number of layers and materials. FIG. 3 also indicates that the IR coatings filter out some UV bands without containing one or more UV absorbers.

In some other implementations, the IR coating can be a ceramic IR coating that includes inorganic oxide nanoparticles. The size ranges of the nanoparticles can be from 50 to 200 nm. These particles can scatter or absorb light in the IR wavelength ranges. The particles can include tin oxide (SnO₂), indium oxide (In₂O₃), and metal hexaboride (such as LaB₆) that blocks IR energy between 700-900 nm. Other particles used can include ruthenium oxide (RuO₂), tantalum nitride (Ta₂N to Ta₃N₅, TaN), titanium nitride (TiN), titanium silicide (TiSi₂), and lanthanum boride (LaB₆, LaB) that block light in the near-IR range. The sizes and types of the particles can be chosen to achieve particular spectra of filtration, such as near-infrared (0.78-3 μm), mid-infrared (3-50 μm), or far-infrared (50-1000 μm).

As shown by the light transmittance spectra in FIG. 3, in addition to filtering out the UV and IR bands, a particular IR coating blocks a portion of light in visible wavelength ranges, and provides a particular shaping of the visible spectra. By blocking and shaping the visible spectra, a particular IR coating can further provide color or tint, such as a dark color. This provides an option for achieving a particular color that is suitable for the application or the user preference of an anti-IR LCMD device.

In some implementations, the IR coating can include nanoparticles of ITO. One advantage of the ITO nanoparticle coating is that does not affect the chemical process of fabricating the anti-IR LCMD devices, because it has been proven that the ITO does not affect the curing process of making the anti-IR LCMD devices. By contrast, some of the metals or metal oxides discussed above may deactivate the curing process. For example, the silver metal may deactivate the polymerization of an epoxy system. Other metals or metal oxides may have an even stronger deactivating effect.

Comparing to regular ITO coatings, the ITO nanoparticle coating offers the advantages of effective IR filtration. However, an ITO nanoparticle coating has a greater thickness compared to a regular ITO coating, and thus is more costly. Further, the ITO nanoparticle coating can be less smooth on the surface.

In some implementations, the IR coating can include a dye type. Similar to the silver metal coating, a color or tint of the dye-type IR coating can be selected by selecting the appropriate type and/or concentration of the dye.

The process for fabricating the anti-IR LCMD film depends on the selected liquid crystals and chemical systems and machinery, as well as the optical, physical, and chemical requirements for the device. In general, the LC-polymer matrix layer in most LCMD films is made by phase separation. The phase separation can rely on two chemical processes, a thermal curing process, or a UV curing process. For a long time, it is challenging to incorporate IR coating in an LCMD device, because the properties of the IR coating may affect the production process of the LC-polymer matrix to meet required optics. On the one hand, an IR coating can block not only the IR spectra but also the UV spectra. Consequently, the IR coating can prevent the use of a UV curing process. On the other hand, the metal elements and their oxides contained in an IR coating may deactivate catalyst causing an abnormal curing result. In addition, it is difficult to conduct formulation research of an LCMD device without knowing what elements are contained in the IR coating. The formulation or compositions of IR coatings usually belong to the trade secrets of coating manufacturers. These may be factors why there has not been such an anti-IR LCMD product on the market.

As will be appreciated by one of skills in the art, resolving instability of LCMD switchable panel apparatuses is considered to be a challenging task, impacted not only by suitable materials but also by the feasibility of manufacturing processes. It is necessary to conduct a large number of experiments for using IR coating in the LCMD system. For a PDLC device, it is not easy to find a new matching condition between the refractive index of polymer np and ordinary refractive index nₒ of liquid crystals after a change of component or reaction condition.

In some implementations, the LC-polymer matrix 140 is an NPD-LCD matrix. The NPD-LCD has a non-linear solid polymer with gradually changed refractive indexes. This is an open system that allows adding a new component without interfering with existing features. NPD-LCD system almost has an “automatic” matching function for refractive indexes, because the inner layer of polymers in droplets is usually formed by relatively fewer active components or monomers with the slowest reactive rate. Therefore, it is relatively easier to find a new matching condition in the NPD-LCD system, as long as the fewer active components are not changed. A new matching condition is usually around existing ones.

In some implementations, the anti-IR LCMD film 100 can be fabricated by using a suitable anti-IR ITO film and an appropriate formulation for the LC matrix 140. The fabrication procedure can be similar to making a regular LCMD film except for replacing the regular ITO film with an anti-IR ITO film or anti-IR dark ITO film.

In a particular example, the LC-polymer matrix layer 140 is an NPD-LCD layer. The process for fabricating the anti-IR LCMD film 100 includes: (i) making a mixture of liquid crystals and monomers and/or oligomers and curing agents and spacers; (ii) configuring two rolls of anti-IR dark ITO films on a film laminator, and allowing the films to have a “Y” shape configuration with ITO facing up; (iii) setting a suitable lamination pressure by adjusting a gap between the two lamination rolls and lamination speed; (iv) adding the mixture between two of the dark ITO films, and starting to laminate two of the dark ITO films together with the mixture in the center; and (v) thermal-curing the laminated film in an oven.

The anti-IR LCMD devices made by incorporating the anti-IR ITO film (also termed as the anti-IR dark ITO film) have many advantages in comparison with traditional dark or colored LCMD devices made by incorporating liquid crystal dyes. Most of the performance data of the traditional dark or colored LCMD products indicate pooper performances, such as higher driving voltage, slower response time, and/or lower transparency, in comparison with a regular LCMD product without containing the dyes, because the dyes dissolved in the liquid crystals increase the viscosity of liquid crystals and thus affect the curing rate and the sizes of LC droplets. Most importantly, the stabilities of the traditional dark or colored LCMD products are weakened, because the dyes used in LCMD products are organic compounds with double bond(s) or triple bond(s) or chromophoric functional group(s) which are usually more vulnerable from the sunlight. The dyes are vulnerable organic compounds and mixed with liquid crystal and polymer and weaken the entire system and its performance.

By comparison, the IR coating of the anti-IR LCMD film 100 can be made of metals or metal oxides that are stable for the sunlight and do not contact with the active layer, and do not affect the optical performance of the device. The techniques described in the specification provide an important improvement in the LCMD field. The resulting devices not only remain at their original level of performance but also have improved lifetime by stabilizing all the organic components by protecting them from the IR and UV rays.

In some implementations, the anti-IR LCMD film 100 further incorporates a UV stabilization technology by using UV absorbers or UV stabilizers introduced in U. S. Patent Application Publication 2015/0275090 A1, or by adding UV absorber(s) into one or more organic components of device 100. Some selected UV absorbers may be added to the LC and monomer formula before curing. Different UV absorbers may be selected to allow the UV absorbers to mainly stay either in the LC microdroplets 140a, or in the solid polymer 140b, or both. For example, if a UV absorber contains an additional functional group that may react with monomer(s) or curing agent(s) in the formula, the UV absorber may be introduced into the solid phase of the solid polymer 140b. Without such an additional functional group, UV absorber(s) will mainly stay in LC microdroplets 140a. In this way, the LC-polymer matrix 140 is protected by both the IR coating and the UV absorbers against harmful rays from the sunlight. The microdroplets 140a and the solid polymer 140b can contain different UV absorbers or the same UV absorbers. Examples of the UV absorbers include benzotriazole and benzophenone and their derivatives with proper aliphatic substituents.

TABLE 1

| Volt (AC) | | 0 | 10 | 20 | 30 | 40 | 50 | 60 | 70 | 80 |
|---|---|---|---|---|---|---|---|---|---|---|
| Haze | NPD-500D1 | 99.31 | 98.65 | 19.05 | 8.85 | 6.59 | 5.51 | 5.11 | 4.61 | 4.52 |
| | NPD-500D2 | 99.41 | 98.88 | 19.09 | 8.22 | 6.21 | 5.24 | 4.71 | 4.35 | 4.29 |
| | NPD-500D3 | 99.33 | 98.88 | 18.51 | 8.32 | 6.29 | 5.41 | 4.95 | 4.59 | 4.23 |

Table 1 lists measurement data obtained by a HunterLab spectrophotometer. Sample NPD-500 is a regular LCD-LCD product without any dye or anti-IR coating (not shown in Table 1). Samples NPD-500D1, NPD-500D2, and NPD-500D3 are anti-IR LCMD films made by incorporating anti-IR dark ITO films with increasing darkness and with the same NPD-500 formula.

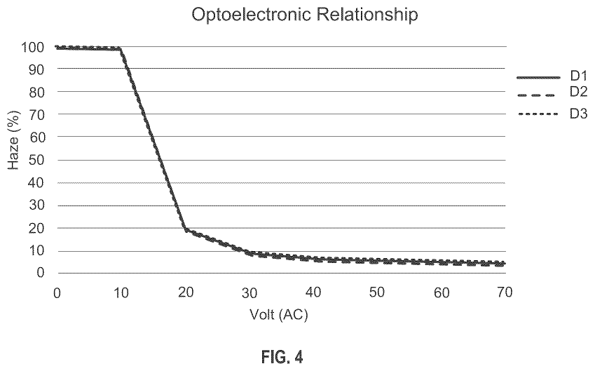

FIG. 4 shows the optoelectronic properties of three samples based on data in Table 1. The optoelectronic curves show haze or scattering levels at different driving voltages. The three curves are almost identical. The optoelectronic curves indicate that hazes are not affected by the darkness levels of the anti-IR dark LCMD films, because their active layer or LC-polymer matrix layers are the same, although different anti-IR ITO films make the different darkness. These properties demonstrate a great advancement to the LCMD field. Traditional dark or colored LCMD devices made by incorporating dyes have poor optoelectronic properties with increased darkness or color, because the dyes affect many aspects in the formulation including solubility, viscosity, size of LC droplets, reaction rate, etc. Further, the higher the concentration of dyes, the greater the impact on the traditional dark LCMD devices. It is the first time to obtain independent optoelectronic performance of dark LCMD device with different degrees of darkness and color while the optoelectronic performances are as good as a regular LCMD device. Thus, the optoelectronic performance of the dark LCMD device with different degrees of darkness and color is achieved without compromising the performance of the device. This new feature is important for many applications, such as aviation applications, energy-saving windows, switchable projection windows, and aesthetic effects on buildings.

TABLE 2

| | NPD- | NPD- | NPD- | NPD- |
|---|---|---|---|---|
| PARAMETER (50 V AC) | 500 | 500D1 | 500D2 | 500D3 |
| Haze (VL, power-off) | 99.3% | 99.3% | 99.3% | 99.3% |
| Haze (VL, power-on) | 5.5% | 4.5% | 4.5% | 4.5% |
| VL transmittance (power-off) | 0.1% | 0.1% | 0.1% | 0.1% |
| VL transmittance (power-on) | >70% | 44% | 27% | 17% |
| IR transmittance (power-off) | 13% | 2% | 1% | 0.4% |
| IR transmittance (power-on) | 82% | 44% | 23% | 13% |
| UV transmittance (power-off) | 0% | 0% | 0% | 0% |
| UV transmittance (power-on) | 31% | 14% | 7% | 4% |

Table 2 shows comparisons of the switching optoelectronic properties among LCMD devices. NPD-500 is a regular film sample without a dye or anti-IR coating. NPD-500D1, NPD-500D2, and NPD-500D3 are anti-IR dark LCMD film samples made by incorporating anti-IR dark ITO films with increasing darkness and the same NPD-500 formula. The haze data are obtained by a HunterLab's spectrophotometer with visible light (VL) and other data are obtained by a solar film spectrometer. The data show that transparencies are improved with anti-IR ITO film, because haze is caused by scattered light rays that are affected by sizes of liquid crystal droplets with wavelength-dependent effects. Since some scattered wavelengths of haze in red and purple have been filtered by anti-IR coatings, the hazes and transparency of anti-IR dark LCMD devices are improved. The anti-IR dark LCMD film may be used in different product structures such as a film 100, a laminated glass panel 200A, and a switchable projection panel 200B.

In Table 2, the infrared switching capability of a regular NPD-LCD product is between 13% at power-off and 82% at power-on. This optical property has been used on building windows for energy saving. Since LCMD is a scattering material without significant absorption, the LCMD switchable window (commercially called smart window) is not hot under the sunlight and does not require cooling. Its switching function is capable of dynamically controlling energy transfer.

Besides privacy functions, energy-saving function of the LCMD devices has begun to receive attention from architectural design and glass industries. With a continuous improvement in stability for outdoor applications, the LCMD devices begun to show its advancement in energy-saving field. A distinctive feature of dynamic control of LCMD devices without involving absorption is different from window tinting film and low-e glass.

In many situations, a dynamic control provides a better solution than a fixed energy-saving solution. An effort for saving energy in one situation can be a drawback in another situation. For example, absorptive or reflective window films or low-e glass block IR rays in the summer. This provides energy saving by using less air-conditioning. But the blocking effect may cause more energy consumptions from heating in the winter. With the microdroplet scattering (including backscattering) feature of the LC-polymer matrix, an LCMD device can efficiently handle both situations with its switching function and dynamic control capability and save energy in both situations. It may block the heat-generating light with scattering mode in summer, but allow the heat-generating sunlight into a room with the clear mode in winter. During a winter night, it can prevent the indoors heat from escaping with its scattering mode. The opacity of an NPD-LCD film can be changed by different voltages from completely clear to completely opaque, and the levels of opacity and transparency are controllable. A computer can automatically control the opacity of the window or ceiling lighting to minimize energy use for day and night in all seasons. Therefore, overall high efficiency in energy saving can be achieved.

NPD-LCD glass/films with spherical scattering have been extensively used on some world-class projects as building's ceiling glass and wall glass as well as on automobiles and ships. However, in order to extend the lifespan of the LCMD devices for outdoor applications, there is an urgent need to provide better protections for such outdoor applications of LCMD devices. Anti-IR coating provides ideal additional protection for LCMD devices in such applications.

Data in Table 2 also show that UV light may be effectively blocked by the anti-IR coating. Combining the stabilizing feature of using anti-IR coating with the feature of using UV stabilizers disclosed in patent publication US 20150275090 A1 will provide stronger protection and give a longer lifespan of the products. For building glass with considering energy saving, a darker film may result in more IR absorption. In this case, the darkness of the IR coating needs to be carefully balanced against the scattering effect to achieve the best result for energy saving. When a lighter anti-IR dark LCMD film is chosen, the protective role of UV stabilization technology introduced in US 20150275090 A1 will increase, therefore, the usage of UV absorber(s) may be increased.

FIG. 1B shows a cross-sectional view of another example of anti-IR LCMD film 100B. For the purpose of reducing cost and/or producing different colors, the IR coating 120a can be added to only one side of the LCMD film. For example, an IR layer in the internal (e.g., the indoor) side can be omitted in certain applications, because the harmful radiations usually come from the outside of a window. The layer structure of the anti-IR LCMD film 100B can include: a first transparent film 110a, an IR coating 120a, a first transparent and conductive coating 130a, an LC-polymer matrix 140, a second transparent and conductive coating 130b, and a second transparent film 110b. Each of the film surfaces 150a and 150b can be an air-solid interface or an air-film interface.

UV absorber(s) may be also added to any of the organic components in anti-IR LCMD films 100 including transparent film 110a and 110b. UV stable ITO film is commercially available. Different colors can be presented on the external side and the internal side according to the IR coating used and located.

FIG. 1C shows a cross-sectional view of another example of anti-IR LCMD film 100C. For purpose of reducing cost and/or having different colors and/or reducing reflection, an IR coating 120a may be added in a different location in an LCMD film. For example, an IR layer can be added to only the external side of an LCMD film, because harmful radiations usually come from outside of a window. The layer structure of the anti-IR LCMD film 100C can be: an IR coating 120a, a first transparent film 110a, a first transparent and conductive coating 130a, an LC-polymer matrix 140, a second transparent and conductive coating 130b, and a second transparent film 110b. Each of the film surfaces 150a and 150b can be an air-solid interface or an air-film interface.

UV absorber(s) may be also added into any of the organic components in an anti-IR LCMD film 100C. Different colors can be presented on the external side and the internal side according to the IR coating used and located.

In general, for protection against the IR rays and UV rays from the sunlight, an IR coating should be on the external side of the LC-polymer matrix layer. The IR coating may be on any surface or interface in an LCMD device according to the application. However, not all types of anti-IR coating are suitable to be configured on an external surface. For example, a silver type IR coating is easy to be oxidized without further protection and is not suitable to be configured on an external surface. A ceramic IR coating, on the other hand, is stable and can be configured on an external surface.

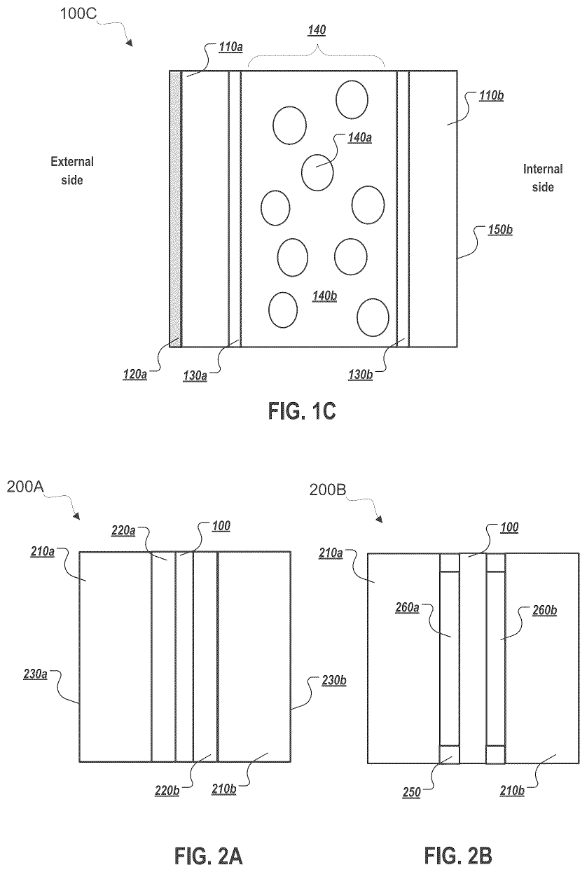

FIG. 2A shows a cross-sectional view of a laminated anti-IR LCMD panel 200A. The laminated anti-IR LCMD panel 200A includes an anti-IR LCMD film 100 laminated between two layers of glass 210a and 210b with two adhesive interlayers 220a and 220b. The interlayer material may include, for example, polyvinyl butyral (PVB), ethylene-vinyl acetate (EVA), or thermoplastic polyurethane (TPU). The glass surfaces 230a and 230b can be an air-solid interface. In this specification, the term “laminated” describes a layer structure in which a film (e.g., an LCMD film) and one or more layers of a solid material (e.g., glass) are separated by an adhesive interlayer extending across substantially the entire interface between the film and the solid material.

The anti-IR LCMD film 100 can be the anti-IR LCMD film 100A, 100B, or 100C described with references to FIG. 1A, 1B, or 1C, respectively. The anti-IR LCMD film provides IR and UV protection for the laminated anti-IR LCMD panel 200A.

FIG. 2B shows a cross-sectional view of a panel apparatus 200B. The panel apparatus 200B includes an anti-IR LCMD film 100 positioned between two layers of glass 210a and 210b. A seal 250 extends around a perimeter between the glass 210a/210b and the anti-IR LCMD film 100. The seal 250 traps or sandwiches an air layer 260a/260b between the anti-IR LCMD film 100 and the glass 210a/210b. Thus, an interface between the glass 210a/210b and the air layer 260a/260b is a solid-air or a glass-air interface, and the interface between the anti-IR LCMD film 100 and the air layer 260a/260b is a solid-air or film-air interface. To ensure uniformity of the air layer 260a/260b in a large size, solid spacers, such as ball shaped plastic spacers, can be added within the air layer 260a/260b.

Other configurations and inclusion or omission of components of the apparatus 200B are possible. In this specification, the term “air-sandwiching” can be understood to include creating a gap for or trapping air or another gaseous material (e.g., a gaseous material with optical properties similar to air) between the glass and the anti-IR LCMD film and include a gap of vacuum. For example, the use of an inert gas, such as argon gas, as the trapped gaseous material can allow the panel to insulate the heat and thus provide a better energy savings.

In various alternative embodiments, an air-tight seal is not required between the anti-IR LCMD film 100 and the glass 210a/210b. Rather, any form of spacing component that produces a gap and provides a bond between the anti-IR LCMD film 100 and the glass 210a/210b can be used. In these embodiments, airflow through the gap can be present.

The anti-IR LCMD film 100 can be the anti-IR LCMD film 100A, 100B, or 100C described with references to FIG. 1A, 1B, or 1C, respectively. The anti-IR LCMD film provides IR and UV protection for the laminated anti-IR LCMD panel 200A and the air-sandwiched LCMD panel 200B.

In this specification, the glass mentioned in different structures or embodiments may be any silicon-based glass such as annealed glass, low iron glass or clear glass or temped glass, or polymer-based glass such as acrylic and polycarbonate panel. The transparent film 110 may be organic polymer films such as polyethylene terephthalate (PET) film or polycarbonate film.

In summary, this specification introduces two methods to increase stabilities against the sunlight for switchable LCMD devices, that is, the use of IR coating to filtrate out the harmful IR ray and UV ray from the sunlight and use of UV absorber to stabilize organic components in the switchable devices. The method of using IR coating may be used alone or with the UV absorber method. Suspended particle devices (SPDs), electrochromic or thermochromic materials have similar structures and applications as well as the same needs to increase stabilities in outdoor environments. As discussed herein, these methodologies will also resolve the instability problem on those devices. With the basic layer structures described above, a different optically active layer determines a type of switchable device. An optically active layer may be selected from an LCMD material, an SPD material, an electrochromic material, or a thermochromic material.

What is claim is:

1. A Liquid Crystal Micro-Droplet (LCMD) apparatus, comprising:
a transparent layer;
a transparent conductive layer;
a liquid crystal-polymer matrix layer that comprises a solid polymer and a plurality of liquid crystal droplets dispersed within the solid polymer; and
an infrared filtration layer wherein the infrared filtration layer stabilizes the apparatus from IR radiation and UV radiation.

2. The apparatus of claim 1, further comprising a compound which stabilizes the apparatus from UV radiation and the compound is present in one or more of the plurality of liquid crystal droplets and the solid polymer and the transparent layer.

3. The apparatus of claim 1, wherein the infrared filtration layer comprises a layer of a dielectric material coated with silver.

4. The apparatus of claim 1, wherein the infrared filtration layer comprises a layer of a dielectric material disposed with nanoparticles.

5. The apparatus of claim 1 or claim 2, wherein the infrared filtration layer comprises nanoparticles of indium tin oxide (ITO).

6. The apparatus of claim 1, wherein the infrared filtration layer is configured between the transparent layer and the transparent conductive layer, wherein a first surface of the infrared filtration layer is in contact with the transparent layer and a second surface of the infrared filtration layer is in contact with the transparent conductive layer.

7. The apparatus of claim 1, wherein a first surface of the infrared filtration layer is configured in contact with the transparent layer and a second surface of the infrared filtration layer is in contact with an external environment of the LCMD device.

8. The apparatus of claim 1, wherein the infrared filtration layer is a first infrared filtration layer, and the LCMD further comprises a second infrared filtration layer.

9. The apparatus of claim 8, wherein the first infrared filtration layer and the second infrared filtration layer have a same thickness.

10. The apparatus of claim 8, wherein the first infrared filtration layer and the second infrared filtration layer have different thicknesses.
